(19) United States
(12) Patent Application Publication
(10) Pub. No.: US 2008/0022516 A1
(43) Pub. Date: Jan. 31, 2008

(54) PRODUCTION SYSTEM FOR MAKING IMPRINTED PRODUCTS AND METHOD FOR TRANSPORT OF THE PRODUCTS

(75) Inventor: Hendrik FRANK, Erkelenz (DE)

Correspondence Address: HEIDELBERGER DRUCKSMASCHINEN AKTIENGESELISCHAFT;C/O KEATING & BENNETT, LLP, 8180 GREENSBORO DRIVE, SUITE 850, MCLEAN, VA, 22102, US

(73) Assignee: HEIDELBERGER DRUCKMASCHINEN AG, Heidelberg (DE)

(21) Appl. No.: 11/780,497

(22) Filed: Jul. 20, 2007

(30) Foreign Application Priority Data
Jul. 26, 2006 (DE) 10 2006 034 509.6
Jul. 26, 2006 (DE) 10 2006 034 511.8
Jun. 28, 2007 (DE) 10 2007 030 271.3

(51) Int. Cl. B23P 19/00; G05B 11/00

(52) U.S. Cl. 29/791; 700/19

(57) ABSTRACT

A production system for manufacturing imprinted products from sheets of paper, cardboard, and the like, includes several printing machines, several punching machines and a common control unit. The printing machines are linked to the punching machines via a transport system with linear-driven transport mechanism such that the products from one particular printing machine can be taken to any given punching machine, and the transport path of the products is controlled by a control unit. The control unit optimizes the workload of all the machines by dictating the product transport pathways.

### BACKGROUND OF THE INVENTION

1. Field of the Invention

The present invention relates to a production system including printing and punching machines for making imprinted products and a method for controlling the transport of products in such a production system.

2. Description of the Related Art

Packaging materials of paper, cardboard, carton or corrugated cardboard are imprinted primarily on sheet printing machines, punched out in sheet format, and folded into boxes and glued. In the punching process, furthermore, fluted lines or blind impressions can also be made in the finished copy units. This complex process makes it indispensable to punch the sheets individually. Since the end products are packages which are demanding in terms of technical and graphic design (such as packages for cosmetics, cigarettes, drugs, foodstuffs, etc.), special requirements are placed not only on the packaging materials themselves, but punching dies with the smallest tolerances and punching machines that work extremely precisely and reliably are also required for optimal results.

These demands are best met by flat-bed punches. Here, the sheets, imprinted and stacked on a pallet, are fed to the punching machine. In the layout, the sheets being punched are oriented register-true in an orienting mechanism, grabbed by a gripper cart and positioned exactly in the punching mechanism between a fixedly mounted lower table and an upper table that is capable of being moved vertically by a bent lever or eccentric gearing.

Such a flat-bed punch is known, for example, from DE 30 44 083 A1. The two tables are outfitted with cutting and grooving dies or corresponding counter-dies, with which the finished copies are punched out from the sheets, brought in timed fashion between the table surfaces, and at the same time, the grooves needed for neat folding are impressed. At the following breakaway mechanism, the scraps are removed mechanically by breakaway dies. Finally, depending on the outfitting of the machine, the punched copies can be separated in a copy separation mechanism provided for this purpose.

Production systems in the prior art for making imprinted products consist of printing and punching machines with no direct material flow linkage. This requires external storage after the printing, usually on pallets, a stack transport, usually by means of pallet lift trucks, interim storage, and subsequent placement back in the punch. This procedure is detrimental on account of the resulting spoilage, the space required for storage surfaces, and the expense in time and manpower.

Moreover, rotary punches are known. In these, the punching dies are arranged on blade shafts which are located in the printing machine. The drawback to this solution is the limiting of the material thickness to around 0.5 mm, a low punching force, and the limited configuration. Other difficulties are involved in the breakaway of the waste scraps.

### SUMMARY OF THE INVENTION

In order to overcome the problems described above, preferred embodiments of the present invention provide a production system that eliminates the drawbacks of the prior art.

A production system according to a preferred embodiment of the present invention for making imprinted products from sheets of paper, cardboard, and the like, especially folded boxes, preferably includes several printing machines, several punching machines and at least one control unit. The machines may possess only one common control unit or, in addition to a common control unit, they can each have their own control unit. The printing machines are linked to the punching machines via a transport system in such a way that the products from one particular printing machine can be taken to any given punching machine. The transport path of the products is controlled by the common control unit.

In another advantageous preferred embodiment of the production system, several folded box gluing machines are included. Printing machines, punching machines, and folded box gluing machines are linked together via a transport system in such a way that the products from a particular printing machine can be delivered to any given punching machine and from a particular punching machine to any given folded box gluing machine. The transport path of the products is controlled in this case by the common control unit.

In another advantageous preferred embodiment of the production system, each printing machine is coordinated with a separate processing station downstream from it. The processing stations can be, in particular, drying stations. The transport system advantageously links a particular printing machine to the coordinated processing station and a particular processing station to any given punching machine. The transport path of the products from processing station to punching machine is likewise governed by the common control unit.

In one advantageous preferred embodiment, the production system preferably includes a transport unit arranged to transport the products, and the empty transport unit can be taken from one particular punching machine to any given printing machine on a transport pathway. The transport pathway of the transport unit is governed by the common control unit.

In one advantageous preferred embodiment, the control unit of the production system, by dictating the product transport pathways, optimizes the workload of all the machines. For this, an optimization algorithm is stored in memory in the control unit.

In one advantageous preferred embodiment of the production system, the transport system includes a linear-driven transport mechanism. In a first variant, the transport unit includes carts to receive pallets, and a stack of products can be transported on each pallet. In a second variant, the transport unit includes gripper carts, and a single sheet can be transported by a gripper cart. In various preferred embodiments, the gripper carts can be moved through printing machines and/or processing stations and/or punching machines. In an especially advantageous preferred embodiment, the gripper carts pick up sheets in the sheet feeder region of the particular printing machines, transport the sheets through the printing machines and further through the punching machines, and pass off the sheets to folded box gluing machines. The empty gripper carts are transported back to the printing machines once again.

Another preferred embodiment of the present invention provides a method of controlling the transport of imprinted products made of sheets of paper, cardboard, and the like in a production system including several printing machines and several punching machines. In a first step of the method, the job data for the products being made in the production system are retrieved by the control unit of the production system. After this, the work status of all printing machines and punching machines at the moment is reported to the control unit of the production system. Based on this data, the medium-term workload of all printing machines and punching machines is calculated by the control unit of the production system. The control unit of the production system now calculates transport paths for the products from a particular printing machine to a punching machine. The calculation of the medium-term workload of the transport paths for the product is done using an optimization algorithm, and the calculations are repeated until such time as a maximum is found for the overall workload of all machines. The track switches of the transport system of the production system are activated in accordance with the transport paths thus found and the products are transported by transport units along these transport paths.

Another preferred embodiment of the present invention provides an alternative production system for the making of further processed printing products from sheets of paper, cardboard, and the like including a printing machine and a punching machine. The machines are linked together via a transport system, which has a linear-driven transport mechanism, including gripper carts.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 illustrates a production system linked via pallet carts to printing and punching machines.

FIG. 2 illustrates a production system linked via gripper carts to printing and punching machines and processing stations.

FIG. 3 illustrates a production system linked via gripper carts to printing and punching machines.

FIG. 4 illustrates a production system linked via gripper carts to printing, punching and folded box gluing machines.

### DETAILED DESCRIPTION OF PREFERRED EMBODIMENTS

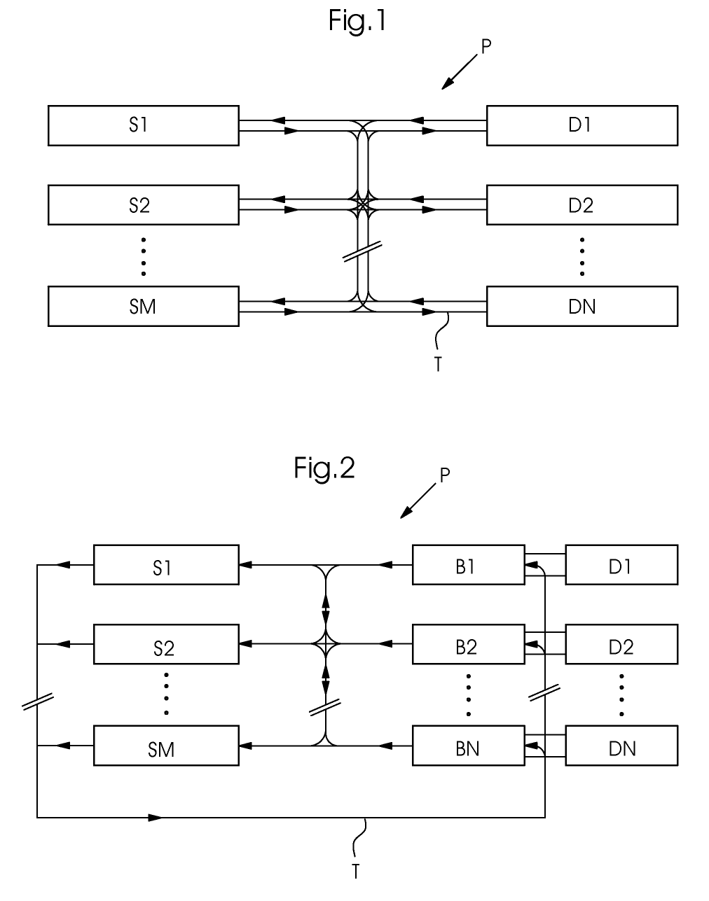

FIG. 1 shows a production system P preferably including several printing machines D1, D2 to DN and several punching machines S1, S2 to SM. The printing machines D1, D2, DN are linked by a transport system T to the punching machines S1, S2, SM. At the delivery unit (not shown) of a particular printing machine D1, D2, DN, the products (not shown) are stacked on pallets. The pallets are picked up by a transport unit and can be taken via the transport system T to any given punching machine S1, S2, SM. There, the pallets with the product stacks drive into the sheet feeder area of a particular punching machine S1, S2, SM. The choice of the transport paths by the transport system T and the activating of the track switches of the transport system T is done by a control unit (not shown).

FIG. 2 shows a production system P including printing machines D1, D2, DN and processing stations B1, B2, BN. Each printing machine is coordinated with a processing station. Moreover, the production system P has punching machines S1, S2 to SM. The transport system T links a particular printing machine to its coordinated processing station, i.e., D1 to B1, D2 to B2, etc., and DN to BN. Each processing station B1, B2, BN is linked via the transport system T to each punching machine S1, S2, SM. The transport system T has transport units (not shown) which preferably are configured as linear-driven gripper carts. A particular gripper cart picks up a sheet from a printing machine, transports it through the processing station coordinated with the printing machine and on to any given punch, then through the latter, and deposits the punched product onto a stack. The empty gripper cart can be transported back to the printing machines via the transport system T on a separate transport pathway. The choice of the transport paths by the transport system T and the activating of the track switches of the transport system T is done by a control unit (not shown).

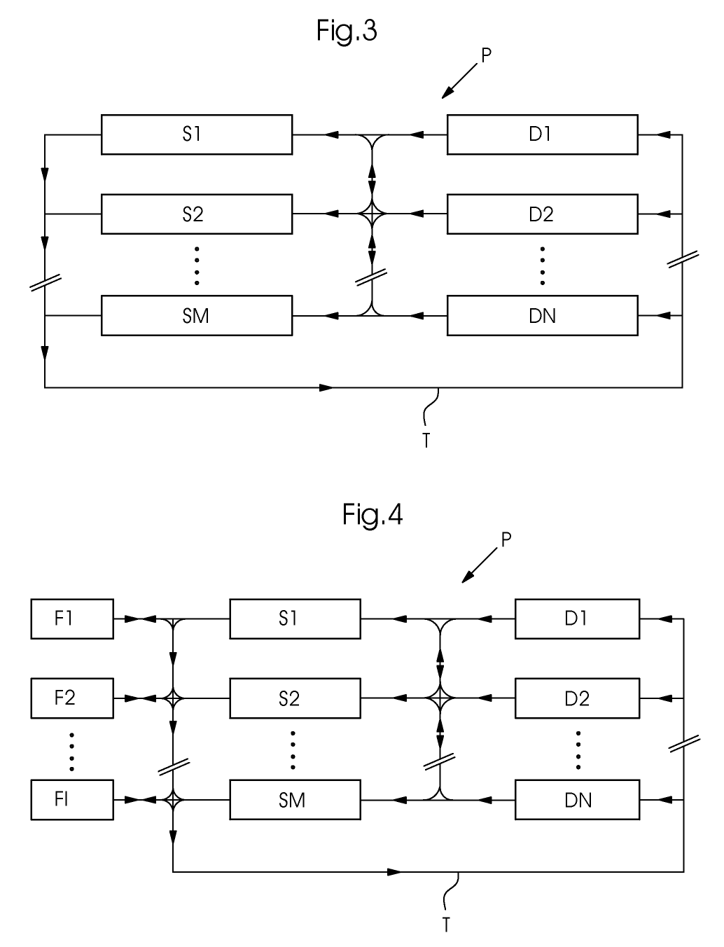

FIG. 3 shows a production system P with printing machines D1, D2 to DN and punching machines S1, S2 to SM. The printing machines are linked by a transport system T to the punching machines. The transport system has linear-driven transport units (not shown), which are preferably configured as gripper carts. The gripper carts can grab a sheet, transport it through the printing machine, then to any given punching machine and through it. After the punched product has been deposited on a stack, the empty gripper cart can be transported back from any given punching machine to any given printing machine on a separate transport pathway. The choice of the transport paths by the transport system T and the activating of the track switches of the transport system T is preferably made by a control unit (not shown).

FIG. 4 shows a production system P similar to the system of FIG. 3. In addition, however, the production system P preferably includes folded box gluing machines F1, F2 to FI, which are linked by the transport system T to the punching machines S1, S2 to SM. A punched product can thus be taken from any given punching machine S1, S2, SM by the transport units (not shown) of the transport system T to any given folded box gluing machine F1, F2, FI. The choice of the transport paths by the transport system T and the activating of the track switches of the transport system T is made by a control unit (not shown).

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A production system for making imprinted products comprising:
a plurality of printing machines;
a plurality of punching machines;
at least one control unit; and
a transport system arranged to link the printing machines to the punching machines such that the product at one of the printing machines is capable of being moved to any of the punching machines, and a transport path of the products is determined by the at least one control unit.

2. The production system according to claim 1, further comprising a plurality of folded box gluing machines, wherein the punching machines are linked to the folded box gluing machines via the transport system such that the product from one of the punching machines is capable of being moved to any of the folded box gluing machines.

3. The production system according to claim 1, wherein each of the printing machines is coordinated with a separate processing station downstream thereof, and the transport system links a respective one of the printing machines to the coordinated processing station and the processing stations are linked to the punching machines via the transport system.

4. The production system according to claim 1, further comprising transport units adapted to transport the products from one of the punching machines to any of the printing machines along the transport path.

5. The production system according to claim 1, wherein the at least one control unit determines the transport pathway so as to optimize the workload of the system.

6. The production system according to claim 1, wherein the transport system includes a linear-driven transport mechanism.

7. The production system according to claim 4, wherein the transport units include carts adapted to pick up pallets, and a stack of sheets can be transported on each of the pallets.

8. The production system according to claim 4, wherein the transport units include gripper carts, and a single sheet can be transported by one of the gripper carts.

9. The production system according to claim 8, the gripper carts are adapted to move through at least one of the plurality of printing machines, the plurality of punching machines, and a plurality of processing machines.

10. A method of controlling transport of imprinted products manufactured by a production system including printing machines, punching machines, a transport system, and a control unit, the method comprising the steps of:
a) retrieving via the control unit job data for the products being manufactured;
b) determining via the control unit a job status of each of the printing machines and each of the punching machines;
c) calculating via the control unit a medium-term workload of each of the printing machines and each of the punching machines;
d) determining via the control unit transport paths for the products from one of the printing machines to one of the punching machines;
e) repeating steps c) and d) until a maximum for the overall workload of all of the printing machines and punching machines is determined by the control unit;
f) activating track switches of the transport system based on the maximum determined in step e);
g) transporting the products along the calculated transport paths.

11. A production system for making processed imprinted products, the production system comprising:
a printing machine;
a punching machine; and
a transport system including a linear-driven transport mechanism and arranged to link the printing machine to the punching machine.
